(19) United States
(12) Patent Application Publication
(10) Pub. No.: US 2008/0213057 A1
(43) Pub. Date: Sep. 4, 2008

(54) Machine Tool with Two Clamp Points on Separate Carriages

(76) Inventors: Lukas Betschon, Wolfhalden (CH); Christian Glaus, Goldach (CH)

Correspondence Address: MCGLEW & TUTTLE, PC, P.O. BOX 9227, SCARBOROUGH STATION, SCARBOROUGH, NY, 10510-9227, US

(21) Appl. No.: 11/914,483

(22) PCT Filed: May 15, 2006
(86) PCT No.: PCT/CH2006/000257

§ 371 Date: May 21, 2008

(30) Foreign Application Priority Data
May 16, 2005 (CH) 856/05

(51) Int. Cl. B23C 7/00; B23Q 35/10

(52) U.S. Cl. 409/232; 409/84

(57) ABSTRACT

The invention relates to a machine tool for milling workpieces, provided with at least two linear displacement axes and at least one pivot axis for carrying out relative movements between a tool and the corresponding workpiece with a workpiece mounting in which a workpiece may be clamped between two clamping points, whereby one of the linear displacement axes is provided as workpiece axis of the workpiece mounting, by means of which the workpiece may be linearly driven, which is furthermore provided with a tool holder for mounting a cutting machining tool, driven in rotation about a tool axis by means of a tool drive. The same conditions are achieved for workpieces of greatly different length for a highly accurate production, whereby two physically separate carriages (27, 28) for the workpiece mounting are provided, on each of which one of the clamping points (16, 17) is arranged and which both may be linearly driven along the same workpiece axis independently of each other.

### CROSS REFERENCE TO RELATED APPLICATIONS

This application is a United States National Phase application of International Application PCT/CH2006/000257 and claims the benefit of priority under 35 U.S.C. § 119 of CH 856/05 filed May 16, 2005, the entire contents of which are incorporated herein by reference.

### FIELD OF THE INVENTION

The present invention pertains to a machine tool for milling workpieces, which is provided with a tool holder for mounting a cutting machine tool which is rotationally driven for this purpose, which has a workpiece mounting in which a workpiece may be clamped between two clamp points, wherein the machine tool has a plurality of driven displacement axes, the displacement axes being provided, individually or in combination with one another, for generating machining feed movements as relative movement of the machining tool relative to the workpiece during machining of the tool on the workpiece, wherein the tool holder is provided with at least one linear displacement axis of the driven displacement axes and the workpiece mounting is provided with at least two carriages physically separate from one another on which respectively one of the clamp points is disposed, and the two carriages of the workpiece mounting can be driven jointly along at least one driven linear displacement axis.

### BACKGROUND OF THE INVENTION

Machine tools in which the workpiece and the milling tool execute relative pivoting movements about at least one axis and relative linear movements along at least two axes are used for milling workpieces. These comprise displacement axes with which feed movements are produced and should be distinguished from those axes with which pure cutting movements are produced as is the case, for example, for the rotational movement of the workpiece during a rotational machining or for the rotational movement of the tool during milling. In particular, a distinction should be made from those displacement axes with which mere feed movements of the tool or workpiece can be executed in order to receive the workpiece, for example, or transfer it into a specific position, displacement axes for pure feed movements are not actuated during machining of a workpiece.

A larger number of feed displacement axes can also be provided depending on the complexity of the required machining. Thus, at least three linear and two rotational feed axes in only one set-up if possible are advantageous for the production of workpieces having complex geometrical shapes such as vanes or blisks of turbine and compressors.

Particularly in the case of elongated workpieces such as turbine blades or vanes, for example, these are frequently clamped between two clamp points to avoid bending and the resulting large production inaccuracies. In a usual solution for such workpieces, one clamp point is arranged fixedly on a longitudinally moveable carriage whilst a second clamp point can merely be moved longitudinally for the clamping process. The length of this longitudinal mobility and the size of the entire carriage must be designed with reference to the longest workpiece to be machined on the corresponding machine tool. However, this has the disadvantage that particularly with shorter workpieces on the carriage, the bearings of the carriage are subject to a strongly unilateral loading which can result in manufacturing inaccuracies.

A milling machine is already known from WO 03/064089 A1 in which three linear feed displacement axes and a pivot axis are provided in the tool. The workpiece mounting executed as a circular station with two separate carriages is provided with a linear feed displacement axis. The two carriages between which a workpiece can be clamped can be driven independently on one another along their displacement axis. A second workpiece mounting is also provided in the machine tool, to which the workpiece should be transferred in an automated manner. In order to be able to receive the workpiece, the second workpiece mounting should be moveable in various directions. As a feed movement, the carriages of the second workpiece mounting execute movements parallel to the feed axis of the first workpiece mounting. This conceptual design of the machine tool makes it difficult to achieve good rigidity of the machine. In addition, the accessibility of the workpiece is restricted in the X direction despite the movability of the two carriages of each workpiece mounting. Particularly the fact that a second workpiece mounting is provided can be detrimental to the accessibility of the workpiece during its machining.

### SUMMARY OF THE INVENTION

It is therefore the object of the invention to provide a machine tool of the type specified initially with a workpiece mounting having favourable properties, in particular a more variable workpiece mounting, in which equally good conditions for high manufacturing accuracy are also provided for workpieces of substantially different length. Despite these properties, the machine tools according to the invention should as far as possible also provide conditions such that the machine tool can have a high rigidity with respect to deformations.

This object is achieved in a machine tool of the type specified initially according to the invention whereby of the two carriages of the workpiece mounting, at least one is provided with a second linear displacement axis for executing machining feed movements.

The linear movement guides for machining feed movements preferably assigned to the two carriages should preferably be aligned parallel to one another in pairs. The displacement axes of these linear movement guides can advantageously be aligned on the one hand parallel to a longitudinal or clamping axis of the workpiece and on the other hand, transverse thereto so that machining feed movements driven with both clamp points or carriages of the workpiece mounting can be made in two mutually perpendicular direction. Since in such embodiments two linear displacement axes are therefore provided in the tool, such machine tools can be designed as particularly compact and rigid despite the functionality according to the invention.

The solution according to the invention can additionally ensure that, as a result of the clamping of the workpiece, the liner movement guides of both clamp points are exposed to substantially the same static loads. Even in the case of the dynamic loads produced during machining, a more uniform distribution can hereby be achieved over the bearing points. In addition, the solution according to the invention has the advantage that from extremely short workpieces to workpieces whose length corresponds to the length of the workpiece axis, all workpiece lengths can be machined under always identical favourable conditions. Finally, the invention also makes it possible to compensate for geometrical inaccuracies of the base frame by means of the controller so that the manufacturing accuracy can be further improved.

A particularly rigid machine construction which has the advantages of the machine concept according to the invention can be achieved if no more than two linear displacement axes are assigned to the tool holder. In preferred embodiments of the invention, the tool holder can be moved in only two and the workpiece mounting likewise in only two linear machining feed axes. Other than, for example, in WO 03/064089 A1, despite the at least four linear displacement axes, both the tool holder and also the workpiece mounting have the smallest possible number of linear displacement axes which results in a high manufacturing accuracy of the machine tools according to the invention.

At least the movements of the two clamp points along one displacement feed axis, preferably in both displacement feed axes, should be synchronised with one another. Such synchronisation can preferably be achieved by means of hardware- or software-based regulation as part of the controller. The mechanically separate displaceability of the two clamp points or carriages along the same axis can be achieved with particularly low design expenditure if both carriages are arranged on the same rails of the linear movement guides provided for this purpose. In order to achieve a secure and stable arrangement of a workpiece between the two clamp points of the workpiece mounting, detectors can be provided for determining instantaneous positions of both clamp points for the synchronous movement of the two clamp points. Their signals should be fed to a controller. On the basis of the detection signals, the controller can compensate between the setpoint and actual points of the two carriages or the speed of the two synchronously moving carriages. For this purpose the controller can also contain one or more control loops.

The invention is of particular importance in connection with machine tools whose tool holder is pivotable about a pivot axis, where the pivot axis preferably encloses an acute angle with the tool axis of the clamped tool. Furthermore, in appropriate further developments the pivot axis and the tool axis intersect, or at least run very close past one another, where the point of intersection of the position having the shortest distance should be located in the area of the tool tip. With such a solution, pivoting movements of the tool holder in which the tool tip retains its position despite the pivoting movement can be made along one or more translational axes without complex compensating movements. In addition, the torque loading of the axis of rotation as a result of clamping forces is minimized in this case. Such pivoting movements can thus be used for alignment or tracking of the tool whereby good surface quality and accuracy can be achieved, even when the workpiece to be manufactured has a complex contour.

A machine tool according to the invention can furthermore have a circular station whose two clamp points can receive the workpiece and during machining of the workpiece, the latter can be set in rotational movement which is provided as a machining feed movement or as a component of the feed movement of the workpiece relative to the milling tool. The circular station can preferably execute endless rotational movements. In connection with such machine tools as are already described in EP 0 659 520 B1, a number of additional advantages are obtained in connection with the separate and multi-axial displaceability of the preferably two clamp points according to the invention. These consist, for example, in a possible reduction in the moving masses, in particular because the circular station can be more slender. The short machining times which are possible with this machine concept anyway can be further shortened as a result of the small masses to be moved despite the high machining accuracy. The chip flow and the accessibility for exchanging a workpiece or front machining of the workpiece is also improved by using the invention in such a machine tool concept. The content of EP 0 659 520 B1 is therefore completely included by reference particularly with regard to the fundamental structure and the operating mode of such machine tools.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a machine tool according to the invention; and

FIG. 2 is a side view of the machine tool from FIG. 1.

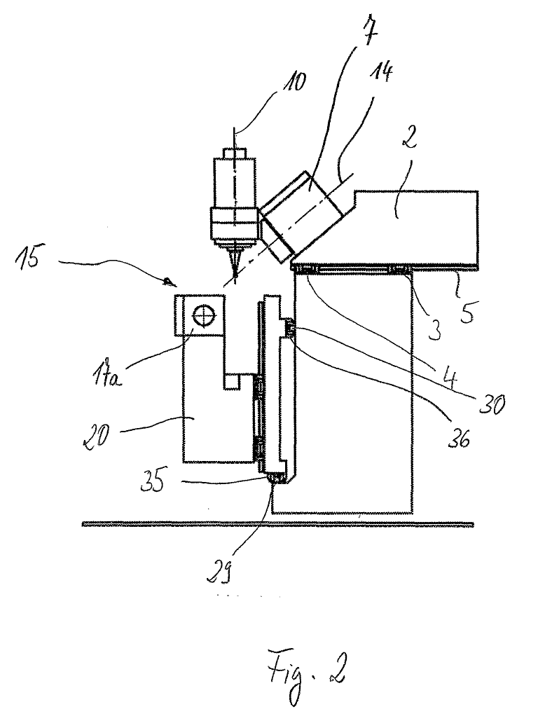

### DESCRIPTION OF THE PREFERRED EMBODIMENTS

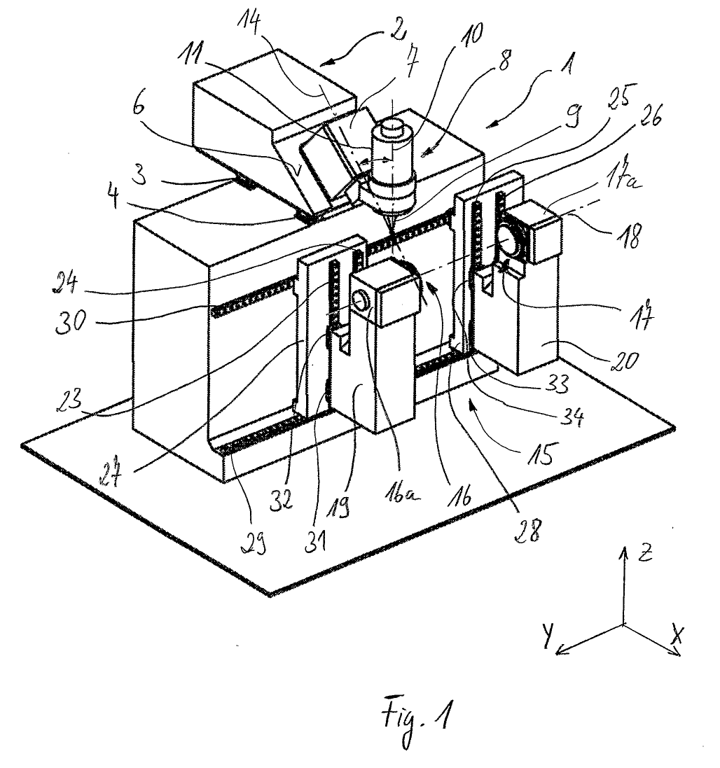

Referring to the drawings in particular, The machine tool shown highly schematically in FIG. 1 is provided with a machine frame 1 having a first carriage 2 arranged on its upper side. The carriage 2 can be driven in the X direction of a Cartesian coordinate system. The displaceability of the carriage 2 is achieved by two linear movement guides running parallel to one another in which a plurality of carriage rollers 3, 4 are arranged on linear displacement rails 5. Of these only one of the rails 5 can be seen in the figures. Such linear movement guides in which rolling bodies circulate in circulating channels in the carriage roller 3, 4 are previously known in many cases. In the present case, the carriage rollers 3, 4 are secured in a fixed position on the machine frame 1 whilst the rails 5 are attached to the movable carriage 2.

The carriage 2 is provided with a sloping surface on which a tool carriage 7 is located. The tool carriage 7 can be driven in the X and Z direction on this surface 6 by means of two further linear movement guides which are not shown.

Attached to the tool carriage 7 is a tool holder 8 in which a milling tool 9 can b mounted and set in rotational movement about a machining axis 10 by a tool drive 11. The cutting speed required for the cutting machining can be produced by the rotational movement. In this case, the tool holder 9 is mounted on the tool carriage 7 so that it can pivot about a driven pivot axis 14. In this case, the pivot axis 14 intersects the axis of rotation (machining axis 10) of the tool 9 at the tool tip. The pivoting movements can be executed during the machining of a workpiece, especially during an existing intervention of the respective tool 9 into a workpiece (not shown in the figures).

Located at the front side of the machine frame 1 as a workpiece holder is a circular station 15 provided with two clamp points 16, 17 between which a workpiece can be clamped. The circular station 15 is provided with a rotational drive 16a, 17a whereby the respective workpiece can be rotated about a clamping axis 18.

The rotational drive 16a, 17a of the circular station 15 can, for example, be allocated to the clamp point 16 to set its workpiece mounting in rotational motion. Preferably both clamp points 16, 17 each have their own rotational drive 16a, 17a.

Each of the clamp points 16, 17 is arranged on a clamp point support 19, 20 which can be driven parallel to the Z axis by means of respectively two parallel linear movement guides. The two clamp point supports 19, 20 are each provided with a dedicated drive (not shown) whereby translational movements of the clamp point supports which are independent of one another per se can be executed. This can be particularly important when a workpiece is only held by one of the clamp points 16, 17. If both clamp points 16, 17 are simultaneously used to mount a workpiece, the movements of the two clamp point supports 19, 20 should be synchronised with one another, for example, by means of suitable sensors whereby the positions of the two clamp points 16, 17 along the Z axis are continuously determined, compared with one another and optionally adapted to one another.

For this purpose, a glass rule with an optical reading head (both not shown) can be provided on at least one linear movement guide of each of the two clamp points 16, 17, which determines an absolute position of the respective clamp point 16, 17 with respect to a reference point. Suitable glass rules for this are supplied, for example, by Heidenheim (for example, product LC181). The signals from the reading heads are supplied to an electronic controller of the machine tools not shown in detail, compared therein and optionally matched to one another by switching on one or both drives of the two clamp points 16, 17. A control loop can be provided for this purpose, which undertakes a re-alignment until, taking into account a predefined tolerance, both clamp points either have a predefined distance and speed or are located at the Z position pre-determined for each clamp point.

The rails 23, 24, 25, 26 of the linear movement guide for the Z axis of each of the two clamp point supports 19, 20 are in turn each arranged on upper sides of a carriage 27, 28 assigned to the respective clamp point support 19, 20. Located on the undersides of both carriages 27, 28 are further linear movement guides whereby the carriages 27, 28 can be translationally driven synchronously or independently of one another in the Y direction. For this purpose the Y axis of the machine tool has two rails 29, 30 of linear movement guides connected to the machine frame. Carriage rollers 31, 32; 33, 34, 35, 36 of these linear movement guides are attached to the carriages, where carriage rollers 31, 32; 33, 34, 35, 36 of both carriages 27, 28 are arranged on the same rails 29, 30. As a result of this design structure and the resulting displaceability of the clamp point supports 19, 20 in the Y and Z direction, the clamp point supports each comprise a cross-carriage.

All the carriages shown here can be provided with commercially available servo motors not shown in detail (e.g. the type IFT6084-1AF71 supplied by Siemens) whose rotational motion is converted into a translational motion by means of a belt drive and ball screw spindle. Alternatively, however, linear direct drives can also be used, for example, similar to the type IFN3600-4WC00-0AA0 supplied by Siemens.

The movements of the carriages 27, 28 along the Y axis can preferably also be synchronised with one another. As in the case of the Z axis, suitable detectors (for example, optical, magnetic or inductive detectors) can also be provided to determine the position of both carriages 27, 28. The signals from the detectors are fed to the controller of the machine tool whereby the movements or positions of the carriages can be regulated.

The machine tool according to the invention is intended for the machining of elongated workpieces having complex geometrical shapes such as, for example, blades of turbines or compressors. In order to clamp such a workpiece in particular, the two clamp points 16, 17 are initially driven apart on the Y axis by means of the carriages with a Y distance which is greater than the length of the workpiece. The workpiece can then be clamped in a collet chuck located in one of the rotationally drivable clamp points 16, 17. The two clamp points can then be moved towards one another in the Y direction until, for example, a centering tip of the other clamp point 16, 17 is located in a centering hole of the workpiece.

The workpiece thus clamped along the clamping axis 18 can be fed to the tool via the driven Y and Z axes on the workpiece side. Feed movements can be achieved with these axes during machining. The same applies for the possible rotation of the workpiece in the circular station around the clamping axis running parallel to the Y axis. For feeding and/or advance movements the tool can be driven simultaneously in the X and Z direction with the carriage in the X axis and with the axis of the tool carriage 7. In addition, the tool can be pivoted by means of its tool holder 8 about the pivot axis 14 of the tool carriage 7 for pivoting movements. As a result of the described alignment of the pivot axis 14 and the pivotability of the tool 9 about this axis, during these pivoting movements the tool 9 describes a path corresponding to a section of an outer surface of a cone, where the cone tip is located at the tool tip. Despite the pivoting movement, the cone tip thus remains in its spatial position with respect to the coordinate system.

It has been shown that by this means, the tool 9 can thus always be optimally aligned on the workpiece surface which is known to be of decisive importance for achieving good surfaces on the workpiece. Unlike in other machine tools, with increasing magnitude of the pivoting movement, the tool holder 8 lies together with the tool 9 next to the workpiece. This allows very large pivot angles which always allows good alignment of the tool on the workpiece for the milling process. In addition, since a balanced loading of both clamp points 16, 17 can be achieved by the invention, overall high-quality work results can be achieved with such machine tools.

Since, in the machine tool according to the invention, the two clamp points can be arranged with a comparatively large distance in the Y direction and in addition, also at a distance from one another in the Z direction, a workpiece can be clamped on one side and its front face machined. A second clamping of the workpiece detrimental to the manufacturing accuracy can hereby be avoided which is why such machining can be carried out with high manufacturing accuracy using machine tools according to the invention.

Finally, it should be noted that all the described axes are driven axes which can be moved separately and simultaneously. The movements are usually produced and controlled by the electronic controller in which programs for manufacturing workpieces can be executed and optionally also stored in suitable storage media.

While specific embodiments of the invention have been shown and described in detail to illustrate the application of the principles of the invention, it will be understood that the invention may be embodied otherwise without departing from such principles.

### REFERENCE LIST

1 Machine frame
2 Carriage
3 Carriage roller
4 Carriage roller
5 Linear movement rail
6 Sloping surface
7 Tool carriage
8 Tool holder
9 Milling tool
10 Machining axis
11 Tool drive
14 Pivot axis
15 Circular station
16 Clamp point
16a Drive
18 Clamping axis
19 Clamp point support
20 Clamp point support
23 Rail
24 Rail
25 Rail
26 Rail
27 Carriage
28 Carriage
29 Rail
30 Rail
31 Carriage roller
32 Carriage roller
33 Carriage roller
34 Carriage roller
35 Carriage roller
36 Carriage roller

1. A machine tool for milling workpieces, the machine comprising:
a tool holder for mounting a rotationally driven cutting machine tool;
a workpiece mounting for clamping a workpiece between two clamp points, wherein the machine tool has a plurality of driven displacement axes, the displacement axes being provided, individually or in combination with one another, for generating machining feed movements as relative movement of the machining tool relative to the workpiece during machining of the tool on the workpiece, wherein the tool holder is provided with at least one linear displacement axis of the driven displacement axes, said workpiece mounting having at least two carriages physically separate from one another on which respectively one of the clamp points is disposed, said at least two carriages of the workpiece mounting being driven jointly along at least one driven linear displacement axis, wherein at least one of said at least two carriages of the workpiece mounting has a second linear displacement axis for executing machining feed movements.

2. The machine tool according to claim 1, wherein the workpiece mounting is configured as a circular station which is provided with an axis of rotation for executing driven feed rotational movement of the workpiece about an axis of rotation running through both clamp points.

3. The machine tool according to claim 1, wherein two clamp points are each provided with a drive for generating a rotational movement of a workpiece.

4. The machine tool according to claim 1, wherein the two carriages can be driven on the same rails of linear movement guides of one of the displacement axes.

5. The machine tool according to claim 1, further comprising a means for synchronizing movements and/or position of the two carriages.

6. The machine tool according to claim 1, wherein in each case, at least one linear movement guide of one of the linear displacement axes is arranged on at least one, preferably on both carriages.

7. The machine tool according to claim 6, wherein the movements of the at least two linear movement guides arranged on the carriages can be synchronized with one another.

8. The machine tool according to claim 7, further comprising a control for synchronizing the at least two linear movement guides.

9. The machine tool according to claim 1, wherein said tool holder is driven in one direction transverse to the workpiece axis.

10. The machine tool according to claim 1, wherein the two clamp points are arranged on respectively one cross-carriage, wherein each of the cross-carriages is configured for executing driven machining feed movements along two displacement axes which are not parallel to one another.

11. The machine tool according to claim 1, further comprising a means for pivoting the tool holder in driven machining feed movements.

12. The machine tool according to claim 11, wherein one pivot axis of the tool holder at least approximately intersects the machining axis.

13. The machine tool according to claim 12, wherein the pivot axis intersects the machining axis at least approximately in the area of a tool tip.

14. A method for milling workpieces in a machine tool in which a tool is held and rotationally driven in a tool holder, the method comprising:
positioning a workpiece between two clamp points of a workpiece mounting, said workpiece mounting having two carriages, wherein each clamp point is located on respectively one carriage and the two carriages are movable at least parallel to one another via machining feed movements, said tool holder being movable along at least one linear displacement axis in a machining feed movement; and
moving said workpiece with at least one of the two carriages in two linear machining feed movements which are aligned non-parallel to one another.

15. The method according to claim 14, wherein during machining with the rotationally driven tool the workpiece executes feed movements in the form of a feed rotational movement about the axis of rotation of the two clamp points.

16. The method according to claim 14, further comprising pivoting movements of the tool holder of the tool during a milling process with the tool.

17. The machine tool according to claim 2, wherein a cutting speed for the milling of a workpiece can be produced with the rotational drive movement of the tool and during the milling, in addition to the cutting speed feed movements of the workpiece can be executed with the feed rotational movement about the axis of rotation of the two clamp points.
